(19) United States
(12) Patent Application Publication
(10) Pub. No.: US 2025/0294463 A1
(43) Pub. Date: Sep. 18, 2025

(54) UL SRS POWER CONTROL UNDER MULTI-TRP OPERATION FOR C-JT

(71) Applicant: Nokia Technologies Oy, Espoo (FI)

(72) Inventors: Antti ARVOLA, Oulu (FI); Bikshapathi GOUDA, Oulu (FI); Italo ATZENI, Oulu (FI); Antti TÖLLI, Oulu (FI); Juha Pekka KARJALAINEN, Oulu (FI); Sami-Jukka HAKOLA, Oulu (FI); Timo KOSKELA, Oulu (FI); Filippo TOSATO, Massy (FR)

(21) Appl. No.: 18/863,162

(22) PCT Filed: Apr. 17, 2023
(86) PCT No.: PCT/EP2023/059884

§ 371 Date: Nov. 5, 2024

Related U.S. Application Data
(60) Provisional application No. 63/339,045, filed on May 6, 2022.

(51) Int. Cl. H04W 52/14; H04W 24/10

(52) U.S. Cl. CPC H04W 52/146; H04W 24/10

(57) ABSTRACT

There is provided a method, computer program and apparatus for causing apparatus at least to: receive a sounding reference signal configuration comprising one or more sounding reference signal resources and/or resource sets for sounding reference signal resource transmission; obtain multiple pathloss reference points from the one or more reference signal resources, the one or more reference signal resources associated with multiple transmission configuration indicator states, the multiple transmission configuration indicator states associated with multiple transmission and reception points having the same or different physical cell identifiers; determine a transmit power level for the sounding reference signal resource transmission to sound a channel for the multiple transmission and reception points, based on a joint metric of the multiple pathloss reference points; determine a set of transmission and reception points of the multiple transmission and reception points, based on the determined transmit power level; and transmit uplink data or a reference signal or control information based on the determined transmit power level from a user equipment to the multiple transmission and reception points within the set, using the one or more sounding reference signal resources.

### TECHNICAL FIELD

The examples and non-limiting example embodiments relate generally to communications and, more particularly, to UL SRS power control under multi-TRP operation for C-JT.

### BACKGROUND

It is known to implement a multiple transmission and reception architecture in a communication network.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2A shows an example multi-TRP system setup.

FIG. 2B illustrates a range for pathloss/RX power tolerance.

FIG. 3A shows a policy based on minimizing the UE power usage.

FIG. 3B shows a policy based on limited maximum UE power.

FIG. 3C shows an RMS-based power control policy.

FIG. 4 is an example apparatus configured to implement the examples described herein.

FIG. 5 is an example method performed with a user equipment to implement the examples described herein.

FIG. 6 is an example method performed with a network node to implement the examples described herein.

### DETAILED DESCRIPTION OF EXAMPLE EMBODIMENTS

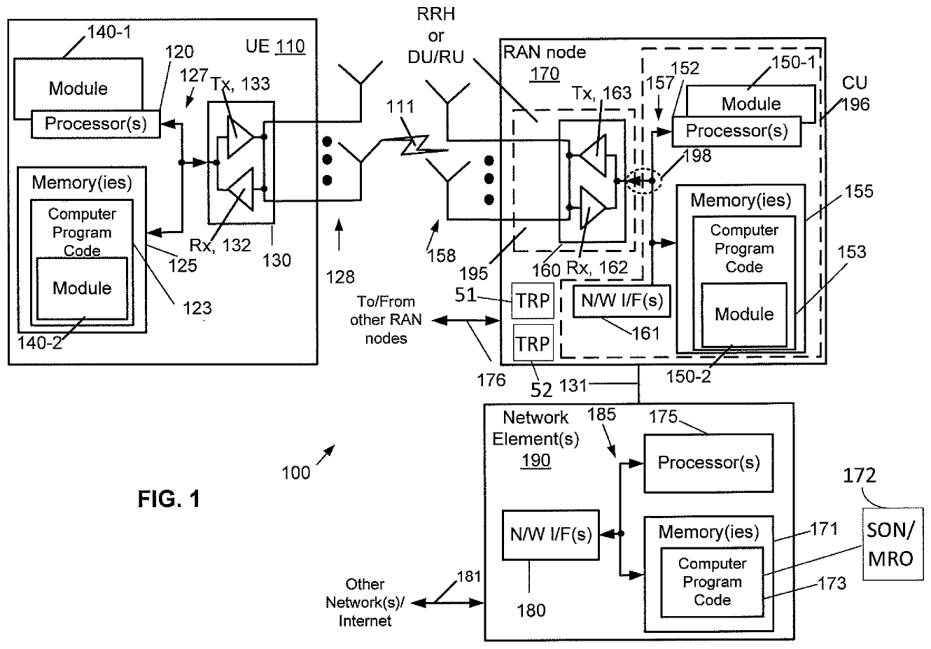

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, it is the functionality which carries UE functionalities. The distributed unit part of the IAB node facilitates the so called access link (child link) connections (i.e. for access link UEs, and backhaul for other IAB nodes, in the case of multi-hop IAB). In other words, it is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including UL SRS power control under multi-TRP operation for C-JT. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

The examples described herein relate to the optimizations of channel estimations in multi-transmission/reception point (mTRP) communications in terms of coherent joint transmission (C-JT) and MIMO. Components of these examples include UEs and gNBs.

The description herein refers to the legacy LTE and current NR specifications and study items. Refer for example to TRs 36.819 and 36.741, which consider COMP principles with details for C-JT and NC-JT and dynamic reference point selection/blanking. However, the current specifications do not involve details of the examples described herein, where the pathloss of multiple TRPs is conditioned to have a more accurate and suitable power level.

The current standard supports adjusting the UE SRS resource set power level based on TCI states, where to sound the channels toward multiple TRPs, multiple SRS resource sets need to be used in sequence to separately sound the different UE-TRP channels. However, this power control does not include different pathloss reference points from multiple TRPs.

In context of the potential problem, the information element pathlossReferenceRS is described within 38.213 and 38.331. 38.331 for example says that pathlossReferenceRS is for a set of reference signals (e.g. a CSI-RS config or a SS block) to be used for pathloss estimation. Multiple candidate pathloss reference RS(s) for SRS power control can be configured, where one candidate RS can be mapped to an SRS Resource Set. However, this focuses on one pathloss (one TRP dependent power), while the examples described herein focus more on pathloss of multiple TRPs to be conditioned to have a more accurate and suitable power level (TRP range dependent power).

Accordingly, the examples described herein propose an UL transmit power control procedure that takes into account the multiple pathloss reference points obtained from multiple TRP-wise TCI states, so that the aggregate channel from the UE to multiple TRPs can be estimated using a single SRS resource. The herein described method makes use of a conditioned pathloss range for enabling one TX power for SRS. Advantages and technical effects of the examples described herein include reduction of signaling overhead and simplification of implementation.

Multi-transmission/reception point (TRP) communications in terms of coherent joint transmission (C-JT) have garnered renewed interest in the proposals for the technical aspects of 3GPP Rel-18 and Rel-19, first for frequency range (FR) 1, and later to be extended to FR2. The current standard already supports multi-point transmission techniques through coordinated multipoint (COMP) via LTE (Rel-11), and dynamic point selection/blanking, which have been further extended to support non-coherent joint transmission (NC-JT). However, the LTE-based COMP-standards need to be updated to bring the support for C-JT to NR. The NR standard also introduced support for several MTRP schemes in Rel-16, based on time-division (TDM), frequency-division (FDM) and spatial-division (SDM) multiplexing of transmission resources. In particular, the MTRP SDM scheme with full overlapping of time and frequency resources applied to PDSCH transmission can take two different forms: NCJT, where each MIMO layer is transmitted from the antenna ports of a single TRP, and CJT, where each layer can be transmitted from the antennas of multiple TRPs. Unlike NCJT, CJT requires phase synchronization between TRPs. Rel-17 introduced CSI reporting for NCJT based on Type-I CSI reporting. Rel-18 is going to extend support for CJT transmission for both FDD and TDD operations. In case of TDD operation, the extension will be based on SRS enhancement to help the gNB obtain the downlink (DL) precoding weights from uplink (UL) channel estimation based on SRS.

One aspect in need of upgrade is the uplink (UL) channel sounding using sounding reference signals (SRS), when the channel matrices are acquired in a multi-TRP scenario. Specifically, the uplink power control in the current standard aims to mitigate the pathloss by adjusting the user equipment (UE) power based on a reference point found in the transmission configuration indicator (TCI) state of a single TRP. Thus, in a multi-TRP setting, where multiple TCI states can exhibit different pathloss reference points based on the individual UE-TRP links, the channel sounding procedure would have to cycle through all the different TRPs sequentially to obtain the individual channels between the UE and all the TRPs, inducing a major overhead increase.

In the current NR standard for UL channel sounding via SRS transmission, the UE adjusts its UL SRS transmit power for all resources within UL SRS set based on a single pathloss reference (pathlossReferenceRS), i.e. a DL reference signal/signal (e.g. NZP-CSI-RS or SSB) that is common for all resources within the UL SRS set), set up by a single (serving) TRP. In a multi-TRP setting, the pathlosses to different TRPs are not necessarily represented by this single DL pathlossReferenceRS. Thus, since only a single pathloss reference can be configured for a UL SRS resource set, i.e., the UE uplink transmission power is adjusted based on a single TRP, the transmit power might not correspond to the optimal power level towards the other TRPs. On one hand, when adjusting the UE transmit power based on a nearby TRP (i.e., low transmit power corresponding to low pathloss), the signal level at a far-off TRP is lowered further from the case when the UE transmits at maximum power. On the other hand, when adjusting the UE transmit power based on a far-off TRP (i.e., high transmit power corresponding to high pathloss), the signal level at a nearby TRP may saturate the automatic gain control, causing near-far problems when multiple UEs need to be served.

Thus, to successfully sound the multi-TRP channel, multiple SRS resources sets must be configured. These sets are transmitted in sequence, which leads to major channel acquisition overhead. This overhead is further multiplied if there is a need for port switching at the UE (e.g., if the UE has more ports than the TRP and needs to cycle through the ports to obtain the port-wise channel information).

Furthermore, this procedure forms separate links between the UE and all the TRPs (multiple channel matrices), whereas a single link to a “virtual” gNB with multiple geographically separated antennas (i.e., a single channel matrix) is more convenient for C-JT operations.

The current 3GPP NR standard supports multi-TRP transmission techniques such as C-JT and dynamic point selection/blanking [TR36.819], along with NC-JT [TR36.741].

The current standard supports adjusting the UE SRS resource set power level based on TCI states. However, this power control does not include different pathloss reference points from multiple TRPs. Thus, to sound the channels toward multiple TRPs, multiple SRS resource sets need to be used in sequence to separately sound the different UE-TRP channels. The standard does not support joint SRS power control based on multiple different pathloss reference points.

Described herein is a new UL transmit power control procedure that accounts for multiple pathloss reference points obtained from multiple TRP-wise TCI states, so that the aggregate channel from the UE to multiple TRPs can be estimated using a single SRS resource.

In brief, described herein is use of a single transmit power level associated with the SRS transmission to simultaneously sound the channel for all TRPs within the serving set.

The power level is set based on a joint metric of the pathloss reference points. These reference points are obtained from pathloss reference RSs associated to (the TRP-wise) TCI states, which are used to configure the SRS resources to be transmitted. To account for all the target TRPs, the TRP with the highest pathloss needs to be the reference, or the TRP must be dropped from the active set. The power level should also consider nearby TRPs so that they are not saturated by excessive UE power usage. These two points hint at a distinct range of pathlosses (or conversely, a range of suitable powers for the received signal) within which the UEs can be served via C-JT. This range of powers could be set by the gNB (based on, for example, its ability to withstand low and high SNR levels) to inform the UE of its active set of TRPs. The active set of TRPs could be limited once the UE transmit power is configured, i.e., the UE reports back the indices of TRPs where the SNR with the configured transmit power falls below the minimum required SNR.

In any of the example embodiments herein the ‘active set of TRPs’ may be simply referred as a ‘set of TRPs’ (e.g. instead of active set of TRPs). Similarly any ‘active set’ may refer simply to a ‘set’.

Using a single power level for the SRS transmission makes the pathloss information implicit in the channel matrix estimated at the gNB (that is, the relative pathloss differences between TRPs), which can then be more accurately accounted for when formulating the downlink precoding matrix for C-JT.

C-JT in a multi-TRP setting requires accurate channel knowledge (gain/loss and phase information) between the UE and all the TRPs belonging to the C-JT serving set. The current standard supports sounding these UE-TRP links separately by configuring separate SRS resource sets for uplink sounding, each with different power control. The SRS resource set is configured with a transmit power level based on the TRP-wise TCI state or, more specifically, the pathlossReferenceRS parameter in the TCI state power control parameters. Intuitively, the UE transmit power for SRS transmission is adjusted to compensate for the pathloss. This mode of operation induces significant overhead, as all the links need to be sounded separately in a time-division manner. Furthermore, if the UE needs to switch antenna ports, the overhead is further increased multiplicatively.

To undertake the channel sounding more efficiently, a single SRS resource set is configured that is received by all serving set TRPs simultaneously. This mode of operation requires the use of a single transmit power, calculated/adjusted based on multiple TCI states, or multiple pathloss parameters, which is not supported by the current standard.

The power level could be based on a joint metric of the pathloss reference points (for K TRPs in the active set, based on the pathlossReferenceRS-values of TCI #1 to TCI #K) indicated to SRS resources to be transmitted. Condition 1: The pathlossReferenceRS corresponding to the highest pathloss (e.g. highest RSRP) within the active set of K TRPs needs to be a reference point. Otherwise, the TRP with the highest pathloss cannot be reached by the SRS transmission. Condition 2: The pathlossReferenceRS corresponding to the lowest pathloss (e.g. lowest RSRP) within the active set of K TRPs needs to be a reference point. Otherwise, nearby TRPs will overhear the SRS transmission, causing saturation at the AGC and inducing near-far problems for other UEs served by the TRP. The active set of TRPs should be adjusted so that Conditions 1 & 2 hold. For example, condition 1 needs to hold, otherwise the channel estimation accuracy degrades. Also for example, condition 2 needs to hold to best avoid AGC saturation.

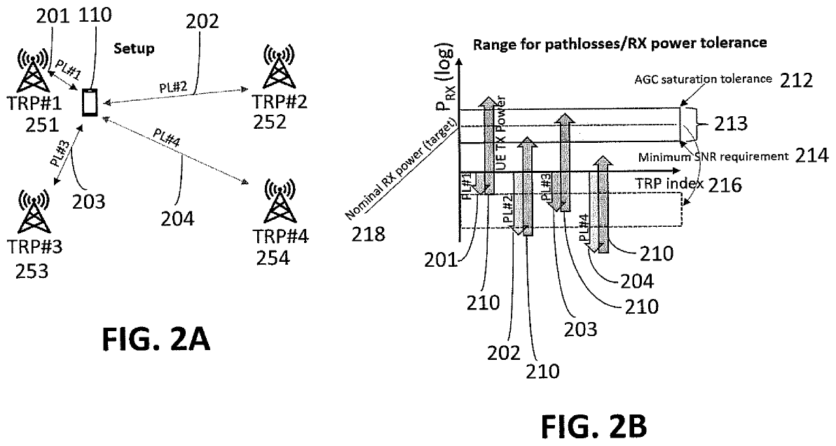

Thus, Conditions 1 & 2 define a range of pathlosses within which the UEs can be served via C-JT. Conversely, there is a tolerance range for received powers that allow for successful channel sounding (i.e., minimum SNR) without saturating the AGC at the receiving TRPs (i.e., maximum UE transmit power). This range is illustrated in FIG. 2A and FIG. 2B.

FIG. 2A shows a setup where a UE 110 is in communication with TRP #1 251 with PL #1 201, TRP #2 252 with PL #2 202, TRP #3 253 with PL #3 203, and TRP #4 254 with PL #4 204. In FIG. 2A, 2 TRPs (e.g. TRP 251 and TRP 252) can be for one gNB (e.g. serving cell) such as RAN node 170 and the other 2 TRPs (e.g. TRP 253 and TRP 254) may be for another cell/gNB (different PCI than the serving cell) such as another RAN node, or all the TRPs (e.g. TRP 251, TRP 252, TRP 253, TRP 254) can be associated with the same cell (e.g. a cell hosted by RAN node 170). Thus FIG. 2A is generalized so that those are TRPs, which may be associated with the same or different PCIs.

In FIG. 2B, a single UE transmit power 210 is used (upward arrow), to compensate for multiple pathlosses (downward arrows) including pathloss #1 201, pathloss #2 202, pathloss #3 203, and pathloss #4 204. Area 213 highlights the received power tolerance range (conversely, the range of pathlosses). As the AGC saturation condition 212 is not as strict as the minimum SNR condition 214, the channels to TRP #1 251 and to TRP #2 252 and to TRP #3 253 can be sounded simultaneously with slight AGC saturation for TRP #1 251. However, the pathloss 204 for TRP #4 254 is too high for accurate channel estimation.

This range 213 could also be used to dynamically adjust the active set of TRPs. Once the UE transmit power for the SRS resource set is configured, the UE 110 can determine which TRPs in the active set fall below the minimum SNR 214. By reporting the indices 216 of these TRPs (in FIG. 2B, the index of TRP #4 254) via uplink signaling, the gNB (e.g. 170) can decide to limit the active set. Also shown in FIG. 2B is nominal Rx power target 218.

There is also the possibility that the AGCs are tuned differently at different TRPs. In this case, the amplification levels should be taken into account during channel estimation and aggregate channel computation. If different AGC levels are utilized, the saturation tolerance should be informed to the UE for UL power control.

Using a single power level for the SRS transmission makes the pathloss information implicit in the channel matrix estimated at the gNB 170 (that is, the relative pathloss differences between TRPs). Thus, instead of estimating multiple separate normalized channel matrices, i.e., H₁, H₂, . . . , H_{K}, a single aggregate channel matrix is estimated, i.e., H′=[α₁H₁ α₂H₂ . . . α_{K}H_{K}], where the combined effects of pathloss and AGC level are reflected by α₁ to α_{K}. This allows the channel gains (relative AGC levels and pathlosses between TRPs) to be more accurately accounted for when formulating the downlink precoding matrix for C-JT based on H′.

For various policies on the UL power adjustment, embodiments include minimum UE power usage, limited maximum UE power, and adjusting the power based on the root-mean-square of the pathlosses.

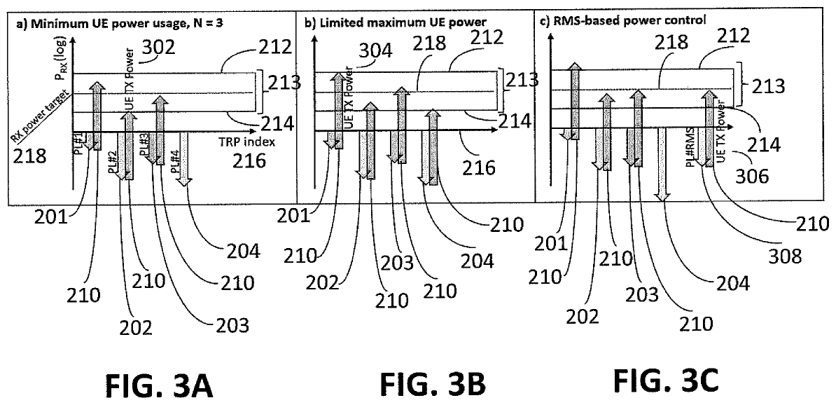

Minimum UE power usage: Limit the active set to the N≥1 TRPs with the best pathloss values. Then, adjust the UE transmit power to the minimum level where the N TRPs can receive the UE transmission with sufficient signal power. This policy minimizes the UE power usage. This policy is illustrated in FIG. 3A. The ‘UE TX power’ text placement 302 marks the pathloss level (now PL #2) that is used to define the transmit power.

Limited maximum UE power: Transmit with the maximum power that does not saturate any nearby TRPs, thus reaching the highest possible amount of TRPs within the active set. This requires knowledge of the AGC saturation tolerance at the UE 110, informed via downlink signaling (for example in the form of ‘nominal power+R dB’, where R is explicitly or implicitly indicated to the UE 110, where nominal power is added to R, where R is the AGC saturation tolerance). This policy allows for maximal active set size without saturation. This policy is illustrated in FIG. 3B. The transmit power for this policy is marked at item 304.

Adjust the power based on the root-mean-square of the pathlosses: The root-mean-square metric will prioritize TRPs that are at an average distance, while less weight is given to the extremes (i.e., TRPs with very low and very high pathloss). Adjusting the UE power based on the root-mean-square value will enable the UE 110 to reach the average-distance TRPs but can induce some saturation at nearby TRPs. The far-off TRPs cannot accurately estimate the channel and should be dropped from the active set. This policy is illustrated in FIG. 3C. The transmit power for this policy is marked at item 306, with the RMS PL marked as item 308.

Advantages and technical effects of the examples described herein include 1-2 immediately following. 1. Instead of configuring multiple SRS resource sets to separately sound all the UE-TRP channels within the active set, only a single SRS resource set is configured. This approach reduces the channel sounding overhead significantly, especially in situations where the UE must undergo port switching. 2. Instead of separately sounding the UE-TRP channels with different uplink powers, using a single power level for the SRS transmission makes the pathloss information implicit in the channel matrix estimated at the gNB (that is, the relative pathloss differences between TRPs), which can then be more accurately accounted for when formulating the downlink precoding matrix for C-JT.

In one example embodiment herein, the proposed method(s) of UL PC for C-JT can be used for different UL SRS use cases, e.g. antenna switching, codebook, non-codebook, beam management and positioning. It should be noted, the use of any methods is not limited to a particular use case.

In any of the embodiments herein, the multiple transmission and reception points (TRPs) may be identified by a CORESETPoolIndex (set of CORESETs), a group index (e.g. a CORESET group index), logical group index (e.g. a set of CORESETs in a group). As an example, the aforementioned group/set/CORESETpoolIndex may be configured with separate TCI states/indicated TCI states (these TCI states may be unified TCI states where a TCI state can indicate transmission and/or reception assumptions associated with the group/set/poolindex), thus there may be more than one active and indicated TCI state (e.g. a plurality of active and indicated TCI states) for UL transmission (also DL) and different TCI states may be determined by the UE to correspond to the transmission/reception to the different TRPs.

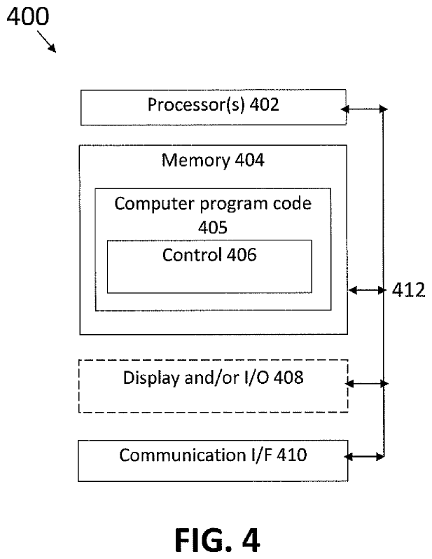

FIG. 4 is an example apparatus 400, which may be implemented in hardware, configured to implement the examples described herein. The apparatus 400 comprises at least one processor 402 (e.g. an FPGA and/or CPU), at least one memory 404 including computer program code 405, wherein the at least one memory 404 and the computer program code 405 are configured to, with the at least one processor 402, cause the apparatus 400 to implement circuitry, a process, component, module, or function (collectively control 406) to implement the examples described herein, including UL SRS power control under multi-TRP operation for C-JT. The memory 404 may be a non-transitory memory, a transitory memory, a volatile memory (e.g. RAM), or a non-volatile memory (e.g. ROM).

The apparatus 400 optionally includes a display and/or I/O interface 408 that may be used to display aspects or a status of the methods described herein (e.g., as one of the methods is being performed or at a subsequent time), or to receive input from a user such as with using a keypad, camera, touchscreen, touch area, microphone, biometric recognition, etc. The apparatus 400 includes one or more communication e.g. network (N/W) interfaces (I/F(s)) 410. The communication I/F(s) 410 may be wired and/or wireless and communicate over the Internet/other network(s) via any communication technique. The communication I/F(s) 410 may comprise one or more transmitters and one or more receivers. The communication I/F(s) 410 may comprise standard well-known components such as an amplifier, filter, frequency-converter, (de) modulator, and encoder/decoder circuitries and one or more antennas.

The apparatus 400 to implement the functionality of control 406 may be UE 110, RAN node 170 (e.g. gNB), or network element(s) 190. Thus, processor 402 may correspond to processor(s) 120, processor(s) 152 and/or processor(s) 175, memory 404 may correspond to memory(ies) 125, memory(ies) 155 and/or memory(ies) 171, computer program code 405 may correspond to computer program code 123, module 140-1, module 140-2, and/or computer program code 153, module 150-1, module 150-2, and/or computer program code 173, and communication I/F(s) 510 may correspond to transceiver 130, antenna(s) 128, transceiver 160, antenna(s) 158, N/W I/F(s) 161, and/or N/W I/F(s) 180. Alternatively, apparatus 400 may not correspond to either of UE 110, RAN node 170, or network element(s) 190, as apparatus 400 may be part of a self-organizing/optimizing network (SON) node, such as in a cloud.

The apparatus 400 may also be distributed throughout the network (e.g. 100) including within and between apparatus 40 and any network element (such as a network control element (NCE) 190 and/or the RAN node 170 and/or the UE 110).

Interface 412 enables data communication between the various items of apparatus 400, as shown in FIG. 4. For example, the interface 412 may be one or more buses such as address, data, or control buses, and may include any interconnection mechanism, such as a series of lines on a motherboard or integrated circuit, fiber optics or other optical communication equipment, and the like. Computer program code 405, including control 406 may comprise object-oriented software configured to pass data/messages between objects within computer program code 405. The apparatus 400 need not comprise each of the features mentioned, or may comprise other features as well.

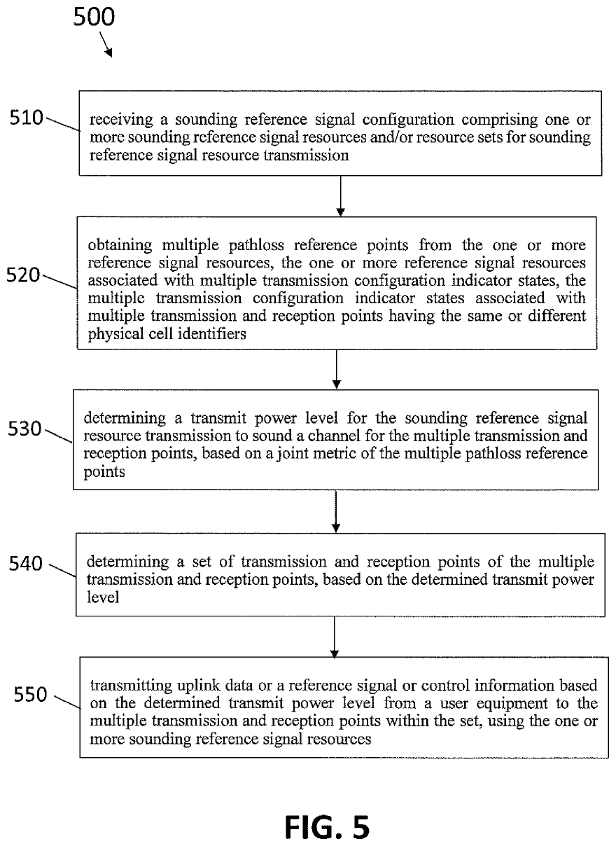

FIG. 5 is an example method 500 to implement the example embodiments described herein. At 510, the method includes receiving a sounding reference signal configuration comprising one or more sounding reference signal resources and/or resource sets for sounding reference signal resource transmission. At 520, the method includes obtaining multiple pathloss reference points from the one or more reference signal resources, the one or more reference signal resources associated with multiple transmission configuration indicator states, the multiple transmission configuration indicator states associated with multiple transmission and reception points having the same or different physical cell identifiers. At 530, the method includes determining a transmit power level for the sounding reference signal resource transmission to sound a channel for the multiple transmission and reception points, based on a joint metric of the multiple pathloss reference points. At 540, the method includes determining a set of transmission and reception points of the multiple transmission and reception points, based on the determined transmit power level. At 550, the method includes transmitting uplink data or a reference signal or control information based on the determined transmit power level from a user equipment to the multiple transmission and reception points within the set, using the one or more sounding reference signal resources. Method 500 may be performed with a user equipment (e.g. UE 110).

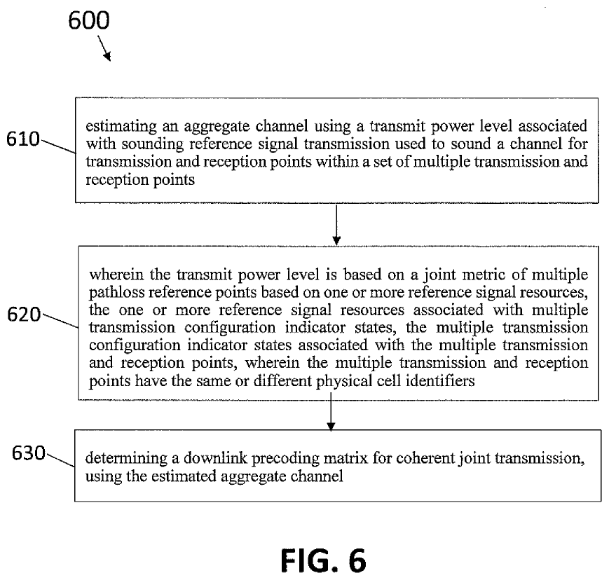

FIG. 6 is an example method 600 to implement the example embodiments described herein. At 610, the method includes estimating an aggregate channel using a transmit power level associated with sounding reference signal transmission used to sound a channel for transmission and reception points within a set of multiple transmission and reception points. At 620, the method includes wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers. At 630, the method includes determining a downlink precoding matrix for coherent joint transmission, using the estimated aggregate channel. Method 600 may be performed with a network node (e.g. RAN node 170).

The following examples (1-51) are provided and described herein.

Example 1. An apparatus includes at least one processor; and at least one memory including computer program code; wherein the at least one memory and the computer program code are configured to, with the at least one processor, cause the apparatus at least to: receive a sounding reference signal configuration comprising one or more sounding reference signal resources and/or resource sets for sounding reference signal resource transmission; obtain multiple pathloss reference points from the one or more reference signal resources, the one or more reference signal resources associated with multiple transmission configuration indicator states, the multiple transmission configuration indicator states associated with multiple transmission and reception points having the same or different physical cell identifiers; determine a transmit power level for the sounding reference signal resource transmission to sound a channel for the multiple transmission and reception points, based on a joint metric of the multiple pathloss reference points; determine a set of transmission and reception points of the multiple transmission and reception points, based on the determined transmit power level; and transmit uplink data or a reference signal or control information based on the determined transmit power level from a user equipment to the multiple transmission and reception points within the set, using the one or more sounding reference signal resources.

Example 2. The apparatus of example 1, wherein the at least one memory and the computer program code are configured to, with the at least one processor, cause the apparatus at least to: perform a respective measurement of a respective channel of the multiple transmission and reception points; and determine one or more subsets of the multiple transmission and reception points, based on the respective measurement of the respective channel of the multiple transmission and reception points.

Example 3. The apparatus of any of examples 1 to 2, wherein the at least one memory and the computer program code are configured to, with the at least one processor, cause the apparatus at least to: perform a respective measurement of a respective channel of the multiple transmission and reception points; report, to a network node, the respective measurement of the respective channel of the multiple transmission and reception points; and receive the sounding reference signal configuration, based on the report.

Example 4. The apparatus of any of examples 1 to 3, wherein the at least one memory and the computer program code are configured to, with the at least one processor, cause the apparatus at least to: perform a respective measurement of a respective channel of the multiple transmission and reception points; determine one or more subsets of the multiple transmission and reception points, based on the respective measurement of the respective channel of the multiple transmission and reception points; report, to a network node, the one or more subsets of the multiple transmission and reception points; and receive the sounding reference signal configuration, based on the report.

Example 5. The apparatus of any of examples 1 to 4, wherein the at least one memory and the computer program code are configured to, with the at least one processor, cause the apparatus at least to: report at least one index of one of the multiple transmission and reception points for which quality metric of one of the multiple transmission and reception points with the transmit power level falls below a threshold related to the quality metric.

Example 6. The apparatus of example 5, wherein the quality metric comprises a reference signal receive power.

Example 7. The apparatus of any of examples 5 to 6, wherein the quality metric comprise a signal to noise ratio.

Example 8. The apparatus of any of examples 1 to 7, wherein the at least one memory and the computer program code are configured to, with the at least one processor, cause the apparatus at least to: determine the set based on a range within which the user equipment is served with coherent joint transmission from the multiple transmission and reception points.

Example 9. The apparatus of example 8, wherein: the range is defined based on a first condition and a second condition; the first condition comprises a pathloss reference signal resource corresponding to a highest reference signal receive power value within the set serving as a first reference point for the range; the second condition comprises a pathloss reference signal resource corresponding to a lowest reference signal receive power value within the set serving as a second reference point for the range.

Example 10. The apparatus of example 9, wherein the at least one memory and the computer program code are configured to, with the at least one processor, cause the apparatus at least to: adjust the set so that the first condition is satisfied for uplink data or reference signal or control information transmission from the user equipment to the transmission and reception points within the set.

Example 11. The apparatus of any of examples 9 to 10, wherein the first condition is satisfied for uplink data or reference signal or control information transmission from the user equipment to the transmission and reception points within the set.

Example 12. The apparatus of any of examples 9 to 11, wherein the at least one memory and the computer program code are configured to, with the at least one processor, cause the apparatus at least to: adjust the set so that the second condition is not satisfied for the uplink data or reference signal or control information transmission from the user equipment to at least one of the transmission and reception points within the set, and the second condition is satisfied for the uplink data or reference signal or control information transmission from the user equipment to at least one other of the transmission and reception points within the set.

Example 13. The apparatus of any of examples 9 to 12, wherein the second condition is not satisfied for the uplink data or reference signal or control information transmission from the user equipment to at least one of the transmission and reception points within the set, and the second condition is satisfied for the uplink data or reference signal or control information transmission from the user equipment to at least one other of the transmission and reception points within the set.

Example 14. The apparatus of any of examples 8 to 13, wherein the range is defined using at least one automatic gain control saturation tolerance as a first reference point, and a minimum signal to noise ratio as a second reference point.

Example 15. The apparatus of example 14, wherein the at least one memory and the computer program code are configured to, with the at least one processor, cause the apparatus at least to: adjust the set so that the uplink data or reference signal or control information transmission from the user equipment to at least one of the multiple transmission and reception points within the set exceeds the at least one automatic gain control saturation tolerance, and the uplink data or reference signal or control information transmission from the user equipment to at least one other of the transmission and reception points within the set does not exceed the automatic gain control saturation tolerance.

Example 16. The apparatus of any of examples 14 to 15, wherein the uplink data or reference signal or control information transmission from the user equipment to at least one of the transmission and reception points within the set exceeds the at least one automatic gain control saturation tolerance, and the uplink data or reference signal or control information transmission from the user equipment to at least one other of the transmission and reception points within the set does not exceed the automatic gain control saturation tolerance.

Example 17. The apparatus of any of examples 14 to 16, wherein different automatic gain control saturation tolerance levels are used for different transmission points of the multiple transmission and reception points.

Example 18. The apparatus of example 17, wherein the at least one memory and the computer program code are configured to, with the at least one processor, cause the apparatus at least to: receive the different automatic gain control saturation tolerance levels; and adjust the set for power control, based on the received different automatic gain control saturation tolerance levels.

Example 19. The apparatus of any of examples 8 to 18, wherein the range is defined based on a received power tolerance.

Example 20. The apparatus any of examples 1 to 19, wherein the transmit power level is determined to compensate for multiple pathlosses associated with the multiple pathloss reference points.

Example 21. The apparatus of any of examples 1 to 20, wherein the transmit power level is configured to be used to estimate an aggregate channel from the user equipment to the multiple transmission and reception points.

Example 22. The apparatus of any of examples 1 to 22, wherein the at least one memory and the computer program code are configured to, with the at least one processor, cause the apparatus at least to: determine pathloss values of the multiple transmission and reception points, using the multiple pathloss reference points; limit the set to the transmission and reception points having the highest pathloss values; and adjust the transmit power level to a minimum level where the transmission and reception points within the set are able to receive transmission from the user equipment with sufficient signal power.

Example 23. The apparatus of any of examples 1 to 22, wherein the at least one memory and the computer program code are configured to, with the at least one processor, cause the apparatus at least to: receive downlink signaling comprising information related to an automatic gain control saturation tolerance level; and determine the transmit power level so that the automatic gain control saturation tolerance level is not exceeded during the uplink data or reference signal or control information transmission.

Example 24. The apparatus of example 23, wherein the downlink signaling is in the form of ‘nominal power+R db’, where R corresponds to the automatic gain control saturation tolerance level.

Example 25. The apparatus of any of examples 1 to 23, wherein the at least one memory and the computer program code are configured to, with the at least one processor, cause the apparatus at least to: determine a root mean square of pathlosses associated with the multiple pathloss reference points; determine the transmit power level using the determined root mean square.

Example 26. The apparatus of example 25, wherein the at least one memory and the computer program code are configured to, with the at least one processor, cause the apparatus at least to: assign a higher priority to transmission and reception points at an average distance from the user equipment relative to priority assigned to transmission and reception points that are relatively farther away from the user equipment.

Example 27. The apparatus of example 26, wherein the at least one memory and the computer program code are configured to, with the at least one processor, cause the apparatus at least to: remove from the set the transmission and reception points that are relatively farther away from the user equipment.

Example 28. An apparatus includes at least one processor; and at least one memory including computer program code; wherein the at least one memory and the computer program code are configured to, with the at least one processor, cause the apparatus at least to: estimate an aggregate channel using a transmit power level associated with sounding reference signal transmission used to sound a channel for transmission and reception points within a set of multiple transmission and reception points; wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers; and determine a downlink precoding matrix for coherent joint transmission, using the estimated aggregate channel.

Example 29. The apparatus of example 28, wherein the aggregate channel is estimated as an aggregate channel matrix.

Example 30. The apparatus of example 29, wherein the downlink precoding matrix is determined using the aggregate channel matrix.

Example 31. The apparatus of any of examples 28 to 30, wherein the at least one memory and the computer program code are configured to, with the at least one processor, cause the apparatus at least to: receive a report of at least one index of the multiple transmission and reception points for which a quality metric of one of the multiple transmission and reception points with the transmit power level falls below a threshold related to the quality metric.

Example 32. The apparatus of example 31, wherein the at least one memory and the computer program code are configured to, with the at least one processor, cause the apparatus at least to: remove one of the multiple transmission and reception points from the set that is associated with the at least one index.

Example 33. The apparatus of any of examples 31 to 32, wherein the quality metric comprises a reference signal receive power.

Example 34. The apparatus of any of examples 31 to 33, wherein the quality metric comprise a signal to noise ratio.

Example 35. The apparatus of any of examples 28 to 34, wherein the at least one memory and the computer program code are configured to, with the at least one processor, cause the apparatus at least to: transmit a sounding reference signal configuration comprising one or more sounding reference signal resources and/or resource sets used for sounding reference signal resource transmission.

Example 36. The apparatus of example 35, wherein the at least one memory and the computer program code are configured to, with the at least one processor, cause the apparatus at least to: determine the transmit power level, the transmit power level associated with the sounding reference signal resource transmission.

Example 37. The apparatus of any of examples 28 to 36, wherein the at least one memory and the computer program code are configured to, with the at least one processor, cause the apparatus at least to: determine a set of factors to apply to channel matrices of the one or more reference signal resources associated with the multiple transmission configuration indicator states; wherein a factor within the set of factors reflects a combined effect of a respective pathloss of the multiple pathloss reference points and a respective automatic gain control level; wherein an aggregate channel matrix of the aggregate channel is estimated as a combination of the channel matrices after the set of factors is applied respectively to the channel matrices.

Example 38. The apparatus of any of examples 28 to 37, wherein the at least one memory and the computer program code are configured to, with the at least one processor, cause the apparatus at least to: determine the set of the transmission and reception points based on a range within which a user equipment is served with coherent joint transmission from the multiple transmission and reception points.

Example 39. The apparatus of example 38, wherein: the range is defined based on a first condition and a second condition; the first condition comprises a pathloss reference signal resource corresponding to a highest reference signal receive power value within the set serving as a first reference point for the range; and the second condition comprises a pathloss reference signal resource corresponding to a lowest reference signal receive power value within the set serving as a second reference point for the range.

Example 40. The apparatus of any of examples 28 to 39, wherein the at least one memory and the computer program code are configured to, with the at least one processor, cause the apparatus at least to: receive, from a user equipment, a report of a respective measurement of a respective channel of the multiple transmission and reception points; and determine a sounding reference signal configuration for the user equipment, based on the report; wherein the sounding reference signal configured is configured to be used with the user equipment to transmit uplink data or reference signal or control information based on a transmit power level from a user equipment to the multiple transmission and reception points within a set; and transmit, to the user equipment, the sounding reference signal configuration.

Example 41. The apparatus of any of examples 28 to 40, wherein the at least one memory and the computer program code are configured to, with the at least one processor, cause the apparatus at least to: perform a respective measurement of a respective channel of the multiple transmission and reception points; receive, from a user equipment, a report of one or more subsets of the multiple transmission and reception points, based on a respective measurement of a respective channel of the multiple transmission and reception points; determine a sounding reference signal configuration for the user equipment, based on the report; wherein the sounding reference signal configured is configured to be used with the user equipment to transmit uplink data or reference signal or control information based on a transmit power level from a user equipment to the multiple transmission and reception points within a set; and transmit, to the user equipment, the sounding reference signal configuration.

Example 42. A method includes receiving a sounding reference signal configuration comprising one or more sounding reference signal resources and/or resource sets for sounding reference signal resource transmission; obtaining multiple pathloss reference points from the one or more reference signal resources, the one or more reference signal resources associated with multiple transmission configuration indicator states, the multiple transmission configuration indicator states associated with multiple transmission and reception points having the same or different physical cell identifiers; determining a transmit power level for the sounding reference signal resource transmission to sound a channel for the multiple transmission and reception points, based on a joint metric of the multiple pathloss reference points; determining a set of transmission and reception points of the multiple transmission and reception points, based on the determined transmit power level; and transmitting uplink data or a reference signal or control information based on the determined transmit power level from a user equipment to the multiple transmission and reception points within the set, using the one or more sounding reference signal resources.

Example 43. A method includes estimating an aggregate channel using a transmit power level associated with sounding reference signal transmission used to sound a channel for transmission and reception points within a set of multiple transmission and reception points; wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers; and determining a downlink precoding matrix for coherent joint transmission, using the estimated aggregate channel.

Example 44. A non-transitory program storage device readable by a machine, tangibly embodying a program of instructions executable with the machine for performing operations, the operations including receiving a sounding reference signal configuration comprising one or more sounding reference signal resources and/or resource sets for sounding reference signal resource transmission; obtaining multiple pathloss reference points from the one or more reference signal resources, the one or more reference signal resources associated with multiple transmission configuration indicator states, the multiple transmission configuration indicator states associated with multiple transmission and reception points having the same or different physical cell identifiers; determining a transmit power level for the sounding reference signal resource transmission to sound a channel for the multiple transmission and reception points, based on a joint metric of the multiple pathloss reference points; determining a set of transmission and reception points of the multiple transmission and reception points, based on the determined transmit power level; and transmitting uplink data or a reference signal or control information based on the determined transmit power level from a user equipment to the multiple transmission and reception points within the set, using the one or more sounding reference signal resources.

Example 45. A non-transitory program storage device readable by a machine, tangibly embodying a program of instructions executable with the machine for performing operations, the operations including estimating an aggregate channel using a transmit power level associated with sounding reference signal transmission used to sound a channel for transmission and reception points within a set of multiple transmission and reception points; wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers; and determining a downlink precoding matrix for coherent joint transmission, using the estimated aggregate channel.

Example 46. An apparatus includes means for receiving a sounding reference signal configuration comprising one or more sounding reference signal resources and/or resource sets for sounding reference signal resource transmission; means for obtaining multiple pathloss reference points from the one or more reference signal resources, the one or more reference signal resources associated with multiple transmission configuration indicator states, the multiple transmission configuration indicator states associated with multiple transmission and reception points having the same or different physical cell identifiers; means for determining a transmit power level for the sounding reference signal resource transmission to sound a channel for the multiple transmission and reception points, based on a joint metric of the multiple pathloss reference points; means for determining a set of transmission and reception points of the multiple transmission and reception points, based on the determined transmit power level; and means for transmitting uplink data or a reference signal or control information based on the determined transmit power level from a user equipment to the multiple transmission and reception points within the set, using the one or more sounding reference signal resources.

Example 47. An apparatus includes means for estimating an aggregate channel using a transmit power level associated with sounding reference signal transmission used to sound a channel for transmission and reception points within a set of multiple transmission and reception points; wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers; and means for determining a downlink precoding matrix for coherent joint transmission, using the estimated aggregate channel.

Example 48. The apparatus of any one of examples 1 to 27, wherein the at least one memory and the computer program code are configured to, with the at least one processor, cause the apparatus at least to: receive, with the user equipment, a set of path loss reference signals; and measure, with the user equipment, the path loss reference signals.

Example 49. The apparatus of example 48, wherein the at least one memory and the computer program code are configured to, with the at least one processor, cause the apparatus at least to: determine, with the user equipment, a sub-set of path loss reference signals based on a metric; and determine, with the user equipment, the transmit power level for the sounding reference signal transmission based on the determined sub-set.

Example 50. The apparatus of example 48, wherein the at least one memory and the computer program code are configured to, with the at least one processor, cause the apparatus at least to: report, with the user equipment, results of the measurement of the path loss reference signals; receive, with the user equipment, a sub-set of pathloss reference signals from a network node; and determine, with the user equipment, the transmit power level for the sounding reference signal transmission based on the received sub-set.

Example 51. The apparatus of claim 50, wherein the network node comprises a gNB.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
3GPP third generation partnership project
4G fourth generation
5G fifth generation
5GC 5G core network
AGC automatic gain control
AMF access and mobility management function
ASIC application-specific integrated circuit
C-JT or CJT coherent joint transmission
COMP coordinated multipoint
CORESET control resource set
config configuration
CPU central processing unit
CSI channel state information
CU central unit or centralized unit
DL downlink
DSP digital signal processor
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FDD frequency division duplex
FDM frequency division multiplexing
FPGA field-programmable gate array
FR frequency range
gNB base station for 5G/NR, i.e., a node providing NR user plane and control plane protocol terminations towards the UE, and connected via the NG interface to the 5GC
IAB integrated access and backhaul
ID identifier
I/F interface
I/O input/output
LMF location management function
LTE long term evolution (4G)
MAC medium access control
MIMO multiple input multiple output
MME mobility management entity
MRO mobility robustness optimization
mTRP or MTRP multi-transmission/reception point
MU multi-user
N number of TRPs
NCE network control element
NC-JT or NCJT non-coherent joint transmission
ng or NG new generation
ng-eNB new generation eNB
NG-RAN new generation radio access network
NR new radio (5G)
N/W network
NZP non-zero-power
P power
PC power control
PCI physical cell ID
PDA personal digital assistant
PDCP packet data convergence protocol
PDSCH physical downlink shared channel
PHY physical layer
PL pathloss
R AGC saturation tolerance level
RAM random access memory
RAN radio access network
RAN1 RAN meeting
Rel- release
RLC radio link control
RMS root mean square
ROM read-only memory
RRC radio resource control (protocol)
RS reference signal
RSRP reference signal receive power
RU radio unit
Rx or RX receiver or reception
SDM spatial division multiplexing
SGW serving gateway
SMF session management function
SNR signal-to-noise ratio
SON self-organizing/optimizing network
SRS sounding reference signal
SS synchronization signal
SU single user
TCI transmission configuration indicator
TDD time-division duplexing
TDM time division multiplexing
TR technical report
TRP transmission and/or reception point
TS technical specification
Tx or TX transmitter or transmission
Type-I codebook designed for SU- or MU-MIMO
UAV unmanned aerial vehicle
UE user equipment (e.g., a wireless, typically mobile device)
UL uplink
UPF user plane function
X2 network interface between RAN nodes and between RAN and the core network
Xn network interface between NG-RAN nodes

1. An apparatus comprising:
at least one processor; and
at least one memory including computer program code;
wherein the at least one memory and the computer program code are configured to, with the at least one processor, cause the apparatus at least to:
receive a sounding reference signal configuration comprising one or more sounding reference signal resources and/or resource sets for sounding reference signal resource transmission;
obtain multiple pathloss reference points from the one or more reference signal resources, the one or more reference signal resources associated with multiple transmission configuration indicator states, the multiple transmission configuration indicator states associated with multiple transmission and reception points having the same or different physical cell identifiers;
determine a transmit power level for the sounding reference signal resource transmission to sound a channel for the multiple transmission and reception points, based on a joint metric of the multiple pathloss reference points;
determine a set of transmission and reception points of the multiple transmission and reception points, based on the determined transmit power level; and
transmit uplink data or a reference signal or control information based on the determined transmit power level from a user equipment to the multiple transmission and reception points within the set, using the one or more sounding reference signal resources.

2. The apparatus of claim 1, wherein the at least one memory and the computer program code are configured to, with the at least one processor, cause the apparatus at least to:
perform a respective measurement of a respective channel of the multiple transmission and reception points; and
determine one or more subsets of the multiple transmission and reception points, based on the respective measurement of the respective channel of the multiple transmission and reception points.

3. The apparatus of claim 1, wherein the at least one memory and the computer program code are configured to, with the at least one processor, cause the apparatus at least to:
perform a respective measurement of a respective channel of the multiple transmission and reception points;
report, to a network node, the respective measurement of the respective channel of the multiple transmission and reception points; and
receive the sounding reference signal configuration, based on the report.

4. The apparatus of claim 1, wherein the at least one memory and the computer program code are configured to, with the at least one processor, cause the apparatus at least to:
perform a respective measurement of a respective channel of the multiple transmission and reception points;
determine one or more subsets of the multiple transmission and reception points, based on the respective measurement of the respective channel of the multiple transmission and reception points;
report, to a network node, the one or more subsets of the multiple transmission and reception points; and
receive the sounding reference signal configuration, based on the report.

5. The apparatus of claim 1, wherein the at least one memory and the computer program code are configured to, with the at least one processor, cause the apparatus at least to:
report at least one index of one of the multiple transmission and reception points for which quality metric of one of the multiple transmission and reception points with the transmit power level falls below a threshold related to the quality metric.

6. The apparatus of claim 5, wherein the quality metric comprises a reference signal receive power.

7. The apparatus of claim 5, wherein the quality metric comprise a signal to noise ratio.

8. The apparatus of claim 1, wherein the at least one memory and the computer program code are configured to, with the at least one processor, cause the apparatus at least to:
determine the set based on a range within which the user equipment is served with coherent joint transmission from the multiple transmission and reception points.

9. The apparatus of claim 8, wherein:
the range is defined based on a first condition and a second condition;
the first condition comprises a pathloss reference signal resource corresponding to a highest reference signal receive power value within the set serving as a first reference point for the range; and
the second condition comprises a pathloss reference signal resource corresponding to a lowest reference signal receive power value within the set serving as a second reference point for the range.

10. The apparatus of claim 9, wherein the at least one memory and the computer program code are configured to, with the at least one processor, cause the apparatus at least to:
adjust the set so that the first condition is satisfied for uplink data or reference signal or control information transmission from the user equipment to the transmission and reception points within the set.

11. The apparatus of claim 9, wherein the first condition is satisfied for uplink data or reference signal or control information transmission from the user equipment to the transmission and reception points within the set.

12. The apparatus of claim 9, wherein the at least one memory and the computer program code are configured to, with the at least one processor, cause the apparatus at least to:
adjust the set so that the second condition is not satisfied for the uplink data or reference signal or control information transmission from the user equipment to at least one of the transmission and reception points within the set, and the second condition is satisfied for the uplink data or reference signal or control information transmission from the user equipment to at least one other of the transmission and reception points within the set.

13. The apparatus of claim 9, wherein the second condition is not satisfied for the uplink data or reference signal or control information transmission from the user equipment to at least one of the transmission and reception points within the set, and the second condition is satisfied for the uplink data or reference signal or control information transmission from the user equipment to at least one other of the transmission and reception points within the set.

14. The apparatus of claim 8, wherein the range is defined using at least one automatic gain control saturation tolerance as a first reference point, and a minimum signal to noise ratio as a second reference point.

15. The apparatus of claim 14, wherein the at least one memory and the computer program code are configured to, with the at least one processor, cause the apparatus at least to:
adjust the set so that the uplink data or reference signal or control information transmission from the user equipment to at least one of the multiple transmission and reception points within the set exceeds the at least one automatic gain control saturation tolerance, and the uplink data or reference signal or control information transmission from the user equipment to at least one other of the transmission and reception points within the set does not exceed the automatic gain control saturation tolerance.

16.-27. (canceled)

28. An apparatus comprising:
at least one processor; and
at least one memory including computer program code;
wherein the at least one memory and the computer program code are configured to, with the at least one processor, cause the apparatus at least to:
estimate an aggregate channel using a transmit power level associated with sounding reference signal transmission used to sound a channel for transmission and reception points within a set of multiple transmission and reception points;
wherein the transmit power level is based on a joint metric of multiple pathloss reference points based on one or more reference signal resources, the one or more reference signal resources associated with multiple transmission configuration indicator states, the multiple transmission configuration indicator states associated with the multiple transmission and reception points, wherein the multiple transmission and reception points have the same or different physical cell identifiers; and
determine a downlink precoding matrix for coherent joint transmission, using the estimated aggregate channel.

29. The apparatus of claim 28, wherein the aggregate channel is estimated as an aggregate channel matrix.

30. The apparatus of claim 29, wherein the downlink precoding matrix is determined using the aggregate channel matrix.

31. The apparatus of claim 28, wherein the at least one memory and the computer program code are configured to, with the at least one processor, cause the apparatus at least to:
receive a report of at least one index of the multiple transmission and reception points for which a quality metric of one of the multiple transmission and reception points with the transmit power level falls below a threshold related to the quality metric.

32. The apparatus of claim 31, wherein the at least one memory and the computer program code are configured to, with the at least one processor, cause the apparatus at least to:
remove one of the multiple transmission and reception points from the set that is associated with the at least one index.

33.-51. (canceled)
